(19) United States
(12) Patent Application Publication
(10) Pub. No.: US 2026/0328581 A1
(43) Pub. Date: Oct. 22, 2026

(54) MAP INFORMATION CREATION DEVICE AND MAP INFORMATION CREATION METHOD

(71) Applicant: HONDA MOTOR CO., LTD., Tokyo (JP)

(72) Inventors: Kazune FURUDO, Tokyo (JP); Masato OKUBO, Tokyo (JP); Eriko YAMAMOTO, Tokyo (JP)

(21) Appl. No.: 19/119,415

(22) PCT Filed: Sep. 28, 2023
(86) PCT No.: PCT/JP2023/035390

§ 371 Date: Apr. 9, 2025

(30) Foreign Application Priority Data
Oct. 13, 2022 (JP) 2022-164990

(51) Int. Cl. G01C 21/00

(52) U.S. Cl. CPC G01C 21/3807; G01C 21/3867

(57) ABSTRACT

The present invention easily links facility information to a parking lot polygon included in map information. A map information creation device 1 comprises: a map information storage unit 122 that stores, as facility information about a plurality of facilities, map information including center position information of each facility, and a plurality of pieces of parking lot polygon information; and a parking lot determination unit 113 that determines a parking lot having the parking lot polygon information, as a parking lot of the facility information having the center position information for which the distance from one node of the parking lot polygon information is the closest.

### TECHNICAL FIELD

The present invention relates to a map information creation device and a map information creation method for easily linking parking lot polygons included in map information and facility information.

### BACKGROUND ART

A use of receiving, with a server, FCD (Floating Car Data) including GPS position information from a plurality of vehicles and utilizing, based on accumulated position information and the like, the FCD for data analysis concerning facilities that the vehicles visited has been spreading. As described in Japanese Unexamined Patent Application, Publication No. 2020-144587, there has been well known a technique of receiving continuous position information from a plurality of vehicles together with hour information, when there is no change in the position information for a predetermined time or more, determining that the vehicles have been parked, and creating a vehicle parking position information table in which the position information is recorded as parking positions of the vehicles together with parking times including date and time information. Here, the vehicle parking position information table indicates a table storing vehicle parking information including at least parking position information, date and time information of parking, and a parking time collected in a predetermined region (for example, a prefecture or a municipality) and in a predetermined period (for example, one year). Here, it is assumed that the parking position information is position information of a vehicle in the case in which there is no change in the position information of the vehicle for a predetermined time or more. The vehicle parking position information table is created based on a position information database (not illustrated) including movement transition information created using FCD (Floating Car Data) including a vehicle ID, position information, and hour information received from, for example, a connected car. The creation of the vehicle parking position information table is the publicly-known technique for those skilled in the art as described in, for example, Japanese Unexamined Patent Application, Publication No. 2020-144587. Note that the vehicle ID can be prevented from being included in the vehicle parking position information table from the viewpoint of personal information protection. In order to correctly grasp, based on position information of a vehicle, that a vehicle user stopped at, for example, a facility annexed with a parking lot, section information of the parking lot and the parking lot being a parking lot of the relevant facility need to be correctly registered on a map. Parking sections are registered in a map layer in a polygon format. This polygon information can also be registered by requesting an external company to register the polygon information. In an existing OSM (Open Street Map), there are also parking lot polygons already registered. However, it is often unknown whether the respective parking lot polygons are parking lots for facility users annexed to the facility or are parking lots for individuals such as monthly parking lots. Further, in the case of a parking lot annexed to a facility, it is often unknown to which facility the parking lot belongs because facility information and a parking lot grid are not linked. For example, WO2019-065328 discloses a technique of dividing map information into a plurality of mesh regions, setting, in the mesh regions, a region where vehicles have been parked a plurality of times as a determination target region and determining, as a home parking lot, the mesh region where a specific vehicle has been parked, and determining, as parking lots of a facility, the mesh regions where unspecified large number of vehicles have been parked. However, the technique described in WO2019-065328 discloses that a facility close to latitude and longitude indicating a region of the parking lot determined as the parking lot of the facility is associated with the parking lot. However, when a plurality of facilities are present, parking lot attributes are merely given. The facilities are not specified.

### CITATION LIST

### Patent Document

Patent Document 1: WO2019-065328
Patent Document 2: Japanese Unexamined Patent Application, Publication No. 2020-144587

### DISCLOSURE OF THE INVENTION

### Problems to be Solved by the Invention

In order to enable an analysis of visitors to a facility with, for example, a big data analysis of FCD acquired from vehicles, there have been demands for a map information creation device and a map information creation method that can easily link a parking lot polygon included in map information and facility information.

The present invention has been made in view of such a problem, and an object of the present invention is to provide a map information creation device and a map information creation method that can easily link, for a facility having center position information, a distance of which from one node of parking lot polygon information is short, a parking polygon included in map information and facility information.

### Means for Solving the Problems

(1) A map information creation device (for example, a map information creation device 1 explained below) of the present invention includes:
   a map information storage (for example, a map information storage unit 122 explained below) that stores map information including center position information of a facility as facility information for a plurality of facilities and a plurality of pieces of parking lot polygon information; and
   a parking lot determiner (for example, a parking lot determination unit 113 explained below) that determines a parking lot having the parking lot polygon information as a parking lot of the facility information having center position information, a distance of which from one node of the parking lot polygon information is shortest.

According to above (1), for a facility having center position information, a distance of which from one node of the parking lot polygon information is short, it is possible to create a map in which a parking lot polygon included in the map information and the facility information are easily linked.
(2) In the map information creation device (for example, the map information creation device 1 explained below), size information indicating a size of the facility may be provided as the facility information,
   the map information creation device (for example, the map information creation device 1) may further include: a parking lot area information table (for example, a parking lot area information table 123 explained below) representing a correspondence relation between an area serving as a size of a facility or a range of the area and a parking lot area of the facility standardly assumed according to the size of the facility or a range of the parking lot area; and
   a facility extractor (for example, a facility extraction unit 112 explained below) that extracts the facility information having center position information, a distance of which from one node of the parking lot polygon information is equal to or shorter than a predetermined distance,
   when two or more pieces of the facility information have been extracted by the facility extractor, the parking lot determiner (for example, the parking lot determination unit 113 explained below)
   may determine, referring to the parking lot area information table, a parking lot having the parking lot polygon information as a parking lot of the facility information having size information close to size information of a facility associated with an area of the parking lot calculated from the parking lot polygon information.

With above (2), when two or more pieces of facility information are present in the vicinity of the parking lot polygon, by comparing an area of the parking lot calculated from the parking lot polygon information with an area of the parking lot calculated based on facility sizes of the two or more pieces of facility information, it is possible to create a map in which the parking lot polygon included in the map information and the facility information are more accurately linked.
(3) In the map information creation device (for example, the map information creation device 1 explained below) described in above (2), the parking lot determiner (for example, the parking lot determination unit 113 explained below) may further,
   when two or more pieces of the facility information have been extracted by the facility extractor (for example, the facility extraction unit 112 explained below), determine a parking lot having the parking lot polygon information as a parking lot of the facility information having size information close to size information of a facility associated with an area of the parking lot calculated from the parking lot polygon information among the facility information having center position information, a distance of which from one node of the parking lot polygon information is shortest, and the facility information having a center position information, a distance of which from the one node is second shortest.

With above (3), by, not via human labor, comparing, an area of the parking lot calculated from the parking lot polygon information with an area of the parking lot calculated based on the facility sizes of the two or more pieces of facility information, it is possible to create a map in which the parking lot polygon included in the map information and the facility information are more accurately linked.
(4) In the map information creation device (for example, the map information creation device 1 explained below), the parking lot determiner (for example, the parking lot determination unit 113 explained below) may further, when, in the facility information having center position information, a distance of which from one node of the parking lot polygon information is shortest, and the facility information having center position information, a distance of which from the one node is second shortest, the respective distances are equal to or shorter than a predetermined distance, determine a parking lot having the parking lot polygon information as a parking lot of the facility information having a large facility size.

With above (4), when, for example, a small facility such as a stall is present at a shortest distance from a parking lot polygon and a shopping mall is present in the vicinity of the parking lot polygon, it is possible to prevent the parking lot polygon from being erroneously determined as a parking lot of the stall.
(5) A map information creation method of the present invention is a map information creation method executed by a computer, including:
   a map information storing step of storing map information including center position information of a facility as facility information for a plurality of facilities and a plurality of pieces of parking lot polygon information; and
   a parking lot determining step of determining a parking lot having the parking lot polygon information as a parking lot of the facility information having center position information, a distance of which from one node of the parking lot polygon information is shortest.

With the method of above (5), the same effects as the effects of the map information creation device in above (1) are achieved.

### Effects of the Invention

According to the present invention, it is possible to provide a map information creation device and a map information creation method that can easily link, for a facility having center position information, a distance of which from one node of parking lot polygon information is short, a parking polygon included in map information and facility information.

### BRIEF DESCRIPTION OF THE DRAWINGS

FIG. 1 is a block diagram illustrating a basic configuration of a map information creation device in an embodiment of the present invention;

FIG. 2 is a diagram illustrating an example of center position information of facilities and polygon information of the facilities and positions and polygon information of parking lots in the embodiment of the present invention;

FIG. 3 is a diagram illustrating a distance between a facility and a parking lot polygon in the embodiment of the present invention;

FIG. 4 is a diagram illustrating an example of a case in which two facilities are located in the vicinity of the parking lot polygon in the embodiment of the present invention; and

FIG. 5 is a flowchart illustrating an operation of linking the parking lot polygon and facility information and creating a map in the embodiment of the present invention.

### PREFERRED MODE FOR CARRYING OUT THE INVENTION

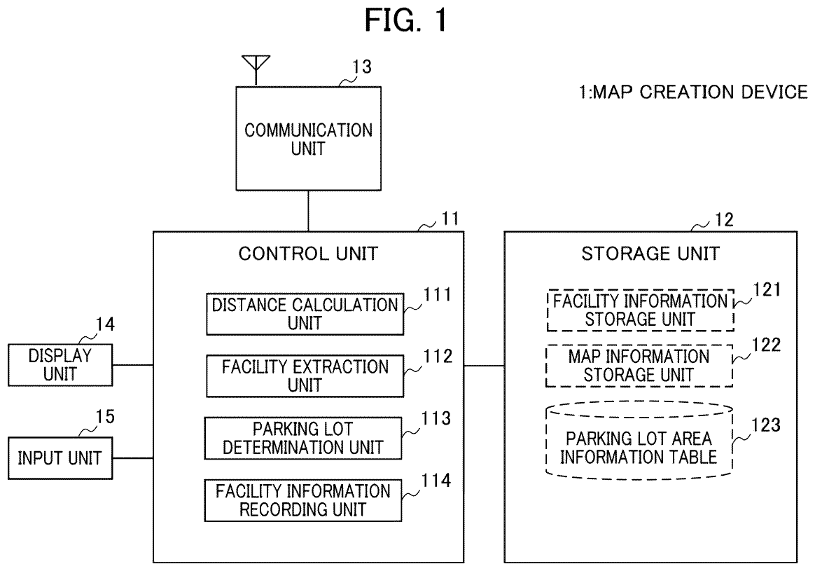

A preferred embodiment of a map information creation device of the present invention is explained in detail below with reference to the figures. A basic configuration of a map information creation device 1 is illustrated in FIG. 1. Functional blocks included in the map information creation device 1 are explained with reference to a block diagram of FIG. 1.

As illustrated in FIG. 1, the map information creation device 1 includes a control unit 11, a storage unit 12, a communication unit 13, a display unit 14, and an input unit 15.

The control unit 11 is configured from an arithmetic processing device such as a microprocessor and controls the units configuring the map information creation device 1. Details of the control unit 11 are explained below.

The storage unit 12 is configured by a semiconductor memory or the like and stores programs such as a program for control called firmware or operating system and a program for performing map information creation processing and further stores various kinds of information such as map information. In the figure, as the information stored by the storage unit 12, a facility information storage unit 121 that stores respective facility information for a plurality of facilities, a map information storage unit 122 that stores map information including center position information of the facilities and polygon information of parking lots, and a facility parking lot area information table 123 are illustrated. Note that, in the embodiment explained below, it is assumed that a coin-operated parking and the like that are not a parking lot of a facility are excluded from a determination target of the present invention in advance. The coin-operated parking and the like are described on a map and can be excluded from the determination target. A parking lot for individuals such as a monthly parking lot can be easily determined based on characteristics; for example, a parking time of parking in the parking lot is long, a parking time at night is particularly long, and the number of vehicles parked at night and the number of parked vehicles calculated from the area of the parking lot are in a close relation. Therefore, the parking lot for individuals can be excluded as a parking lot not included in the determination target of the present invention.

The facility information includes, for example, an identification information (a facility ID) of a facility, a name of the facility, a facility type (and/or a genre) concerning a type of the facility, a telephone number, an address, a business hour, center position information indicating a center position (for example, information of latitude and longitude) of the facility, and a size of the facility (for example, a site area of the facility or a total floor area obtained by totaling floor areas of the facility). Here, the facility type indicates a business category of the facility such as a convenience store, a hospital, or a car dealer.

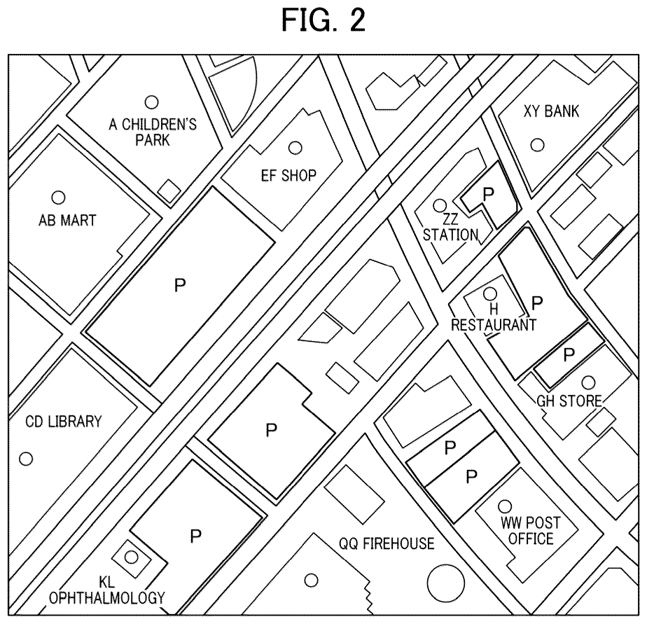

The map information storage unit 122 includes the center position information of the facilities on the map and the polygon information of the facilities and the positions and the polygon information of the parking lots. FIG. 2 illustrates an example of the center position information of the facilities and the polygon information of the facilities and the positions and the polygon information of the parking lots.

The parking lot area information table 123 of the facility indicates a table representing a correspondence relation between an area serving as a size of the facility or a range of the area and a parking lot area of the facility standardly assumed according to the size of the facility or a range of the parking lot area. Here, the area serving as the size of the facility is, for example, a site area of the facility or a total floor area obtained by totaling floor areas of the facility. The area of the parking lot is a site area of the parking lot or, in the case of a multistory parking space, a total floor area obtained by totaling floor areas.

The facility information, the map information including the center position information of the facility and the polygon information of the facility and the position and the polygon information of the parking lot, the parking lot area information table 123, and the like may be configured to be stored in the storage unit 12 in advance or may be configured to be downloaded as appropriate according to necessity from the server device (not illustrated) connected to the communication network 60. Further, these pieces of information may be corrected as appropriate according to, for example, input of a user.

The communication unit 13 includes a DSP or the like and conforms to a standard such as LTE (Long Term Evolution), 4G (4th Generation), or 5G (5th Generation) or a standard such as Wi-Fi (registered trademark) and implements wireless communication or wired communication with another device (for example, the server explained above) via the communication network 60. Note that the communication network 60 is implemented by a network such as the Internet or a cellular phone network or a network obtained by combining the Internet and the cellular phone network. A LAN (Local Area Network) may be included in a part of the network.

The display unit 14 is configured by a display device such as a liquid crystal display or an organic electroluminescence panel. The display unit 14 receives an instruction from the control unit 11 and displays an image. The input unit 15 is configured by an input device (not illustrated) such as a physical switch called ten-key pad or a touch panel provided to be superimposed on a display surface of the display unit 14.

Subsequently, details of the control unit 11 are explained. The control unit 11 is configured by a microprocessor including a CPU, a RAM, a ROM, and an I/O. The CPU executes programs read from the ROM or the storage unit 12 and, in the execution of the programs, reads information from the RAM, the ROM, and the storage unit 12, writes information in the RAM and the storage unit 12, and exchanges signals with the communication unit 13. In this way, hardware and software (programs) cooperate, whereby processing in the present embodiment is implemented.

The control unit 11 includes, as functional blocks, a distance calculation unit 111, a facility extraction unit 112, a parking lot determination unit 113, and a facility information recording unit 114.

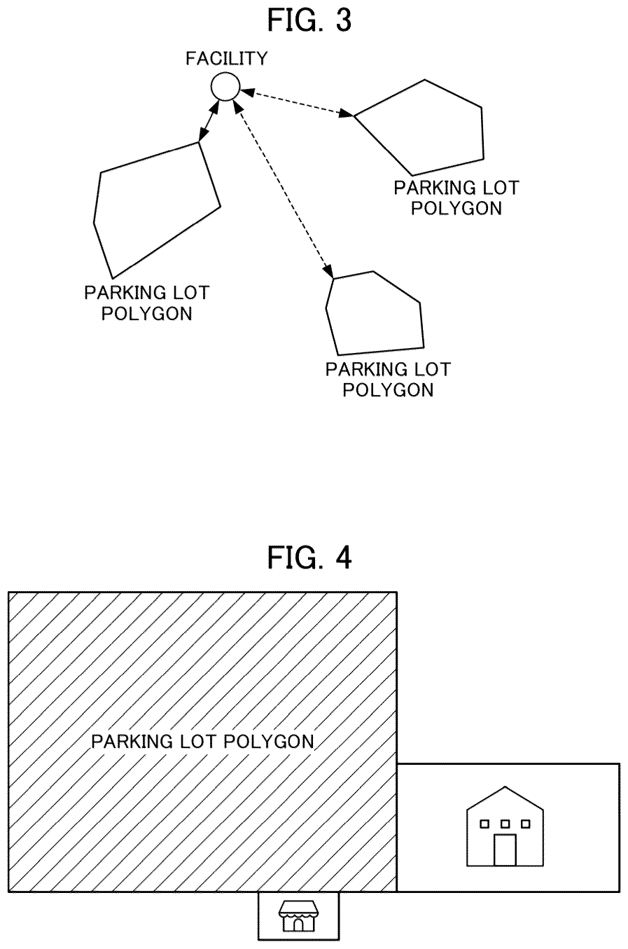

The distance calculation unit 111 calculates a distance between center position information of a facility included in facility information and one node of parking lot polygon information. Here, the one node of the parking lot polygon information means a position included in a parking lot polygon and present at the shortest distance from the center position information of the facility. FIG. 3 is a diagram illustrating a distance between a facility and a parking lot polygon. As illustrated in FIG. 3, the distance between the facility and the parking lot polygon is the shortest distance among distances between the center position of the facility and any positions included in the parking lot polygon. Note that, when the center position of the facility is included in the parking lot polygon, the distance between the center position information of the facility included in the facility information and the one node of the parking lot polygon information is 0 (zero).

The facility extraction unit 112 extracts, for a parking lot having parking lot polygon information selected by the user, facility information having center position information, the distance of which from one node of the parking lot polygon information is equal to or shorter than a predetermined distance.

When facility information (for example, a facility ID) is tagged to the parking lot polygon information, first, the parking lot determination unit 113 determines the parking lot polygon information as a parking lot of a facility identified by the facility ID. When center position information of the facility included in the facility information is included in the parking lot polygon information, the parking lot determination unit 113 determines the parking lot polygon information as a parking lot of the facility. In cases other than the above, the parking lot determination unit 113 may determine the parking lot having the parking lot polygon information as a parking lot of facility information having center position information, the distance of which from one node of the parking lot polygon information is the shortest, among the facility information extracted by the facility extraction unit 112. However, when determining only with the shortest distance, for example, as illustrated in FIG. 4, when a small facility such as a stall is present at the shortest distance of the parking lot polygon and a shopping mall is present in the vicinity of the parking lot polygon, it is likely that the parking lot polygon is erroneously determined as a parking lot of the stall.

To eliminate such a case, when two or more pieces of facility information have been extracted by the facility extraction unit 112, the parking lot determination unit 113 may refer to the parking lot area information table 123 and determine the parking lot as the parking lot of facility information having size information closest to the size information of a facility associated with the area of the parking lot calculated from the parking lot polygon information. When two or more pieces of facility information have been extracted by the facility extraction unit 112, the parking lot determination unit 113 may determine the parking lot as a parking lot of facility information having size information close to size information of a facility associated with the area of the parking lot calculated from the parking lot polygon information among the facility information having center position information, the distance of which from one node of the parking lot polygon information is the shortest, and the facility information having center position information, the distance of which from the one node is the second shortest. In the facility information having center position information, the distance of which from one node of the parking lot polygon information is the shortest, and the facility information having center position information, the distance of which from the one node is the second shortest, when the respective distances are equal to or shorter than a predetermined distance, the parking lot determination unit 113 may determine the parking lot as a parking lot of facility information having a large facility size.

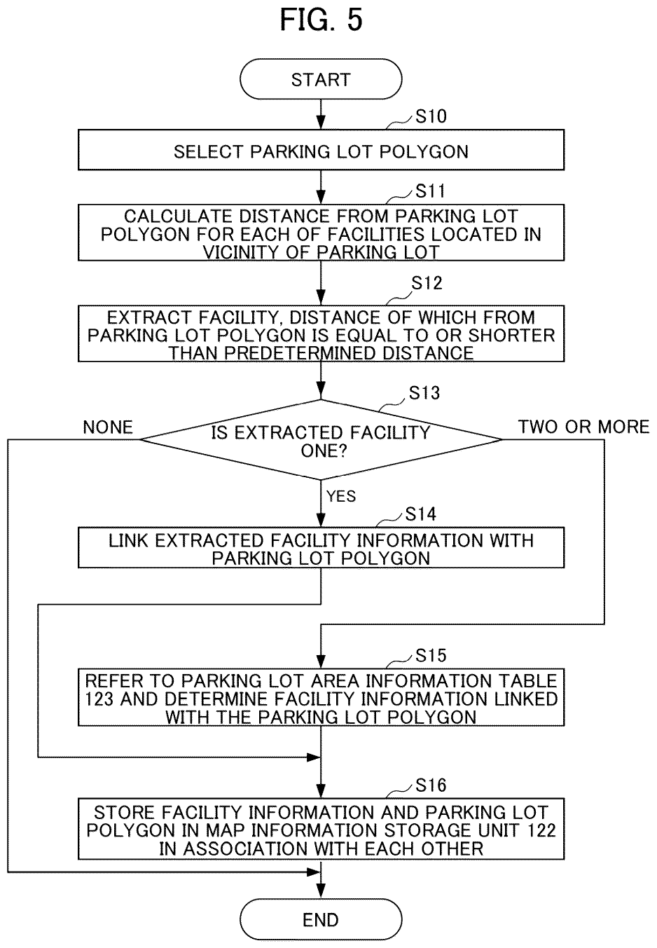

The facility information recording unit 114 stores, in the map information storage unit 122, the facility information determined by the parking lot determination unit 113 in association with the parking lot polygon information. This makes it possible to create, without performing operation for manually linking the facility information with the parking lot polygon included in the map information, a map in which the parking lot polygon included in the map information and the facility information are easily linked. The configurations of the functional units of the map information creation device 1 exemplified as the present embodiment are explained above. Subsequently, an operation in the present embodiment is explained with reference to a flowchart described in FIG. 5. Here, FIG. 5 is a flowchart illustrating an operation of linking a parking lot polygon and facility information and creating a map. Note that, as explained above, it is assumed that a coin-operated parking and the like that are not a parking lot of a facility are excluded from a parking lot polygon of a determination target. When tag information indicating a facility is present in a parking lot polygon and when the parking lot polygon includes center position information of the facility, it is assumed that the facility information is stored in the map information storage unit 122 in linkage with the parking lot polygon. For this reason, in a processing flow described below, such a parking lot polygon is not included in a target.

Referring to FIG. 5, in step S10, the map information creation device 1 (the parking lot determination unit 113) selects one parking lot polygon.

In step S11, the map information creation device 1 (the distance calculation unit 111) calculates, for a parking lot having the parking lot polygon information selected by the user, a distance from the parking lot polygon information for each of facilities located in the vicinity of the parking lot. Specifically, the map information creation device 1 (the distance calculation unit 111) calculates a distance between center position information of the facility and one node of the parking lot polygon information.

In step S12, the map information creation device 1 (the facility extraction unit 112) extracts, for the parking lot having the parking lot polygon information selected by the user, facility information having center position information, a distance of which from one node of the parking lot polygon information is equal to or shorter than a predetermined distance.

In step S13, when the facility information extracted in step S12 is one piece of information, the map information creation device 1 (the parking lot determination unit 113) shifts to step S14. When the extracted facility information is two or more pieces of information, the map information creation device 1 (the parking lot determination unit 113) shifts to step S15. Note that, when extracted facility information is absent, the map information creation device 1 (the parking lot determination unit 113) ends the processing. In step S14, the map information creation device 1 (the parking lot determination unit 113) links the facility information with the parking lot polygon and shifts to step S16.

In step S15, the map information creation device 1 (the parking lot determination unit 113) refers to the facility size information and/or the parking lot area information table 123, determines facility information to be linked with the parking lot polygon, and shifts to step S16.

In step S16, the map information creation device 1 (the facility information recording unit 114) stores the parking lot polygon information and the facility information linked with the parking lot polygon information in the map information storage unit 122 in association with each other.

Accordingly, by performing the operation explained above on the parking lot polygon included in the map information, the map information creation device 1 can associate the facility information with the parking lot polygon.

According to the present embodiment explained above, it is possible to provide a map information creation device and the map information creation method for creating, without manually linking facility information with a parking lot polygon included in map information, a map in which the parking lot polygon included in the map information and the facility information are easily linked.

Each of the devices can be implemented by hardware, software, or a combination of the hardware and the software. A navigation method performed by the devices included in the navigation system explained above cooperating with one another can also be implemented by hardware, software, or a combination of the hardware and the software. Here, the navigation method being implemented by software means the navigation method being implemented by a computer reading and executing a program.

The program can be stored using non-transitory computer-readable media of various types and supplied to a computer. The non-transitory computer-readable media include tangible storage media of various types. Examples of the non-transitory computer-readable media include a magnetic recording medium (for example, a flexible disk, a magnetic tape, and a hard disk drive), a magneto-optical recording medium (for example, a magneto-optical disk), a CD-ROM (Read Only Memory), a CD-R, a CD-R/W, a semiconductor memory (for example, a mask ROM, a PROM (Programmable ROM), an EPROM (Erasable PROM), a flash ROM, and a RAM (random access memory)). The program may be supplied to the computer by transitory computer readable media of various types. An example of the transitory computer readable media include an electric signal, an optical signal, and an electromagnetic wave. The transitory computer-readable media can supply the program to the computer via a wired communication line such as an electric wire and an optical fiber or a wireless communication line.

The embodiment explained above is a preferred embodiment of the present invention. However, the scope of the present invention is not limited to only the embodiment. Implementation in forms applied with various changes in a range not departing from the gist of the present invention is possible.

### Modification 1

For example, the functional configuration illustrated in FIG. 1 does not limit the functional configuration of the present embodiment. That is, it is sufficient that a function that can execute a series of processing concerning a map information creation function of the present invention as a whole is provided in the devices. What kinds of functional blocks are used in order to implement the function is not particularly limited to the example illustrated in FIG. 1. Besides, the embodiment explained above may be modified like, for example, a modification explained below. Note that the modification explained below may be further combined.

### Modification 2

In the embodiment explained above, it is explained that the map information creation device 1 is implemented by one server device or the like. However, a distributed processing system in which the functions of the map information creation device 1 are distributed to a plurality of server devices as appropriate may be adopted. The functions of the map information creation device 1 may be implemented using a virtual server function or the like on the cloud.

### EXPLANATION OF REFERENCE NUMERALS

1 map information creation device
11 control unit
111 distance calculation unit
112 facility extraction unit
113 parking lot determination unit
114 facility information recording unit
12 storage unit
121 facility information storage unit
122 map information storage unit
123 parking lot area information table
13 communication unit
14 display unit
15 input unit
60 communication network

1. A map information creation device comprising:
a map information storage that stores map information including center position information of a facility as facility information about a plurality of facilities and a plurality of pieces of parking lot polygon information; and
a parking lot determiner that determines a parking lot having the parking lot polygon information as a parking lot of the facility information having center position information, a distance of which from one node of the parking lot polygon information is shortest.

2. The map information creation device according to claim 1, wherein
size information indicating a size of the facility is provided as the facility information,
the map information creation device further comprises:
a parking lot area information table representing a correspondence relation between an area serving as a size of a facility or a range of the area and a parking lot area of the facility standardly assumed according to the size of the facility or a range of the parking lot area; and
a facility extractor that extracts the facility information having center position information, a distance of which from one node of the parking lot polygon information is equal to or shorter than a predetermined distance, and
the parking lot determiner,
when two or more pieces of the facility information have been extracted by the facility extractor, determines, referring to the parking lot area information table, a parking lot having the parking lot polygon information as a parking lot of the facility information having size information close to size information of a facility associated with an area of the parking lot calculated from the parking lot polygon information.

3. The map information creation device according to claim 2, wherein
the parking lot determiner further,
when two or more pieces of the facility information have been extracted by the facility extractor, determines a parking lot having the parking lot polygon information as a parking lot of the facility information having size information close to size information of a facility associated with an area of the parking lot calculated from the parking lot polygon information among the facility information having center position information, a distance of which from one node of the parking lot polygon information is shortest, and the facility information having a center position information, a distance of which from the one node is second shortest.

4. The map information creation device according to claim 1, wherein
the parking lot determiner further,
when, in the facility information having center position information, a distance of which from one node of the parking lot polygon information is shortest, and the facility information having center position information, a distance of which from the one node is second shortest, the respective distances are equal to or shorter than a predetermined distance, determines a parking lot having the parking lot polygon information as a parking lot of the facility information having a large facility size.

5. A map information creation method executed by a computer, comprising:
a map information storing step of storing map information including center position information of a facility as facility information for a plurality of facilities and a plurality of pieces of parking lot polygon information; and
a parking lot determining step of determining a parking lot having the parking lot polygon information as a parking lot of the facility information having center position information, a distance of which from one node of the parking lot polygon information is shortest.
